(19) United States
(12) Patent Application Publication
(10) Pub. No.: US 2011/0295387 A1
(43) Pub. Date: Dec. 1, 2011

(54) METHOD AND APPARATUS FOR INTEGRATED DEVICE CONTROL CONSIDERING THE FUNCTIONS AND STATES OF DEVICES

(75) Inventors: Tae-Kwang Um, Jincheon-gun (KR); Cheol-Ju Hwang, Yongin-si (KR); Jae-Hwang Lee, Seoul (KR)

(73) Assignee: SAMSUNG ELECTRONICS CO., LTD., Suwon-si (KR)

(21) Appl. No.: 13/146,120

(22) PCT Filed: Mar. 4, 2009
(86) PCT No.: PCT/KR2009/001052

§ 371 Date: Aug. 11, 2011

(30) Foreign Application Priority Data
Jan. 23, 2009 (KR) 10-2009-0006271

(51) Int. Cl. G05B 11/01

(52) U.S. Cl. 700/12

(57) ABSTRACT

Device integrated-control according to user's needs. A device information providing method for a device integrated-control includes receiving device capability and status information from one or more devices, determining a device-based usage goal example capable of achieving the predetermined aim by using the received device capability and status information, and planning the at least one actions, which have to be executed to attain the device-based usage goal example, for the respective devices, providing information about at least one capability of a device necessary for attaining a usage goal example, which is capable of satisfying user's needs, from the device to a device integrated-controller and providing information about statuses of at least one of the device and content for executing the at least one capabilities from the predetermined device to the device integrated-controller.

### CROSS-REFERENCE TO RELATED PATENT APPLICATION

This application claims the benefit of priority from Korean Patent Application No. 10-2009-0006271, filed on Jan. 23, 2009, in the Korean Intellectual Property Office, the disclosure of which is incorporated herein in its entirety by reference in its entirety. This application is a National Stage entry of International Application No.: PCT/KR2009/001052 filed on Mar. 4, 2009.

### BACKGROUND

1. Field

The present invention relates to a methods and an apparatuses consistent with the disclosed embodiments relate to for booting an image reproduction apparatus, and more particularly, to a method and an apparatus for restarting an image reproduction apparatus when an error has occurred during a booting process.

Methods and apparatuses consistent with the disclosed embodiments relate to device control according to user's needs.

2. Description of the Related Art

Currently, many devices can perform various functions and provide User Interfaces (UIs) which include a variety of methods and tools allowing users to use the devices. To diversify types of devices individually owned by users and allow users to utilize any device, the users need to operate the devices by directly controlling them.

Since each device has unique capabilities and a unique interface for the same, a user should be familiar with the various devices in order to operate them property. To fully explore unique capabilities of each device, the user should learn how to use a UI for each device.

Moreover, even when a user understands capabilities of some device, it should be determined whether that device can currently execute a predetermined capability, and therefore, the user has to check operability for each device.

### SUMMARY

According to an aspect of an inventive concept, there is provided a method for integrated control of at least one device, the method including receiving a user input which requests a predetermined action, receiving device functionality and status information from the at least one device, determining functionality needed to achieve the predetermined action based on the received device functionality and status information, and planning at least one device action, which is to be executed to attain the determined functionality, based on the received device functionality and status information.

The method may further include controlling a corresponding device according to the planned at least one action.

The planning may further include proposing the planned at least one device action to a user and receiving at least one selection of the planned at least one device action from the user.

The device functionality and status information may include at least one of information about a predetermined capability needed to attain the determined functionality from capabilities of a predetermined device selected from the devices determined to execute the planned at least one device action, information about a previous status of the predetermined devices prior to execution of a predetermined capability of the predetermined device, and information about a post status of the predetermined device after execution of the predetermined capability of the predetermined device. The device capability and status information may further include at least one of information about a goal status of a predetermined capability of the predetermined device and information about the needed functionality of the predetermined device.

The device capability and status information may further include at least one of information about multimedia capability of the predetermined device, information about a help manual of a predetermined functionality of the predetermined device, information about a limitation of the predetermined device, information about external connection details of the predetermined device, information about a hardware status of the predetermined device, information about a software status of the predetermined device, and information about a priority for executing a predetermined functionality of the predetermined device.

The method may further include receiving a feedback regarding an action of the controlled device, planning at least one action for a new usage goal example of the device according to the feedback, and reporting information about the feedback to a corresponding user.

The determining may include monitoring a current event of the device and determining the device-based usage goal example based on the received device capability and status information and the monitored current event of the device.

The receiving of the device capability and status information may include accessing a central server on the web and collecting the device capability and status information registered by a corresponding device in the central server.

The device-based usage goal example may be extracted from a database for the integrated control of the at least one devices. The method may be performed by a predetermined device among devices for which the device-based usage goal example is determined, or by a predetermined control server on the web.

The receiving of the device capability and status information may include accessing a corresponding server and collecting the device capability and status information from a database of the corresponding device, or accessing a central server on the web and collecting the device capability and status information registered by a corresponding device in the central server.

According to another aspect of the present invention, there is provided a device information providing method for device integrated-control, the device information providing method including providing by the device to a device, device information about at least one functionality of a device necessary for satisfying user's needs, from the device to a device integrated-controller and providing information about statuses of at least one of the device and content for executing the at least one functionally from the predetermined device to the device integrated-controller, in which the device integrated-controller receives a user input which requests the predetermined action, receives device functionality and status information from the at least one device, determines functionality needed by the device to achieve the predetermined action based on the received device functionality and status information, and plans at least one device action, which is to be executed to attain the determined functionality based on the received device functionality and status information, thereby controlling the device according to the at least one actions planned for the device.

The device integrated-controller may be mounted in at least one of the device, an independent control device capable of communicating with the device through a network, a predetermined device among devices interconnecting with the device through a network, and the control server on the web.

According to another aspect of the present invention, there is provided an apparatus for integrated control of at least one device, the apparatus including a user input unit which receives a user input which requests a predetermined action, a device information receiving unit which receives device functionality and status information from the at least one device, a functionality determining unit which determines functionality needed by the at least one device to achieve the predetermined action based on the received device functionality and status information, and an action planning unit which plans at least one action, which is to be executed to attain the device functionality based on the received device functionality and status information.

The apparatus may further include a device controller for controlling a corresponding device according to the planned at least one action.

The action planning unit may propose the planned at least one action to a user and receive at least one selection of the planned at least one action from the user. The apparatus may receive feedback regarding an action of the controlled device.

According to yes another aspect of the inventive concept, there is provided a device controlled by a device integrated-controller, the device including a device functionality information providing unit which provides from to a device integrated-controller the device information about at least one functionality of a device necessary for attaining functionality needed to satisfy user's needs, and a device status information providing unit which provides information about statuses of at least one of the device and content capability for executing the at least one functionality from the predetermined device to the device integrated-controller, in which the device integrated-controller receives a user input having a predetermined action, receives device functionality and status information from the at least one devices, determines a functionality needed to achieve the predetermined requested action based on the received device functionality and status information, and plans at least one action, which have to be executed to attain the needed functionality based on the received device functionality and status information.

The device may execute at least one actions planned by the device integrated-controller for attaining the needed functionality according to control of the device integrated-controller. The device may also report a feedback regarding an action executed according to control of the device integrated-controller to the device integrated-controller.

According to another aspect of the present invention, there is provided a non-transitory computer-readable recording medium having recorded thereon a program for executing the foregoing method for integrated control of at least one devices.

According to another aspect of the present invention, there is provided a computer-readable recording medium having recorded thereon a program for executing the foregoing device information providing method.

### BRIEF DESCRIPTION OF THE DRAWINGS

The above and/or other features and aspects will become more apparent by describing in detail exemplary embodiments thereof with reference to the attached drawings in which:

FIG. 1 is a block diagram illustrating an apparatus for integrated control of devices according to an exemplary embodiment;

FIG. 2 is a block diagram illustrating a target device which is subject to control of an apparatus that integrates control of devices according to an exemplary embodiment;

FIG. 3 is a diagram illustrating a related-art device use structure in which a user uses various devices;

FIG. 4 is a diagram illustrating a device use structure in which multiple users use a device through an apparatus that integrates control of devices according to an exemplary embodiment;

FIG. 5 is a diagram illustrating a structure in which a user uses a device having mounted therein an apparatus that integrates control of devices according to an exemplary embodiment;

FIG. 6 is a diagram illustrating an example of pseudo code according to a related art Universal Plug and Play (UPnP) scheme;

FIG. 7 is a diagram illustrating an example of pseudo code based on an extended UPnP scheme according to an exemplary embodiment;

FIG. 8 is a flowchart illustrating a method of integrated control of devices according to an exemplary embodiment; and

FIG. 9 is a flowchart illustrating a method of integrated control of devices according to an exemplary embodiment.

### DETAILED DESCRIPTION OF EXEMPLARY EMBODIMENTS

An exemplary embodiment establishes a device integrated-control environment for controlling a device by determining a usage example for each device according to user's needs.

Integrated control of devices according to an exemplary embodiment of adopts action planning, which is one of fields of artificial intelligence, to efficiently use a device connected to a network. In particular, through a device integrated-control apparatus and a control target device according to an exemplary embodiment, the device integrated-control apparatus in place of a user performs goal-oriented action planning which reflects user's needs, thereby allowing the user to control and use various devices without a need to fully know usage examples of the respective devices.

Since the device integrated-control apparatus should have knowledge of various capabilities and current status of the control target device to perform goal-oriented action planning for the control target device, the control target device provides various information about its capabilities and status. As long as such information is provided in a standardized manner, a user-friendly device integrated-control environment may be established where the user can easily control and efficiently use various devices connected to the network.

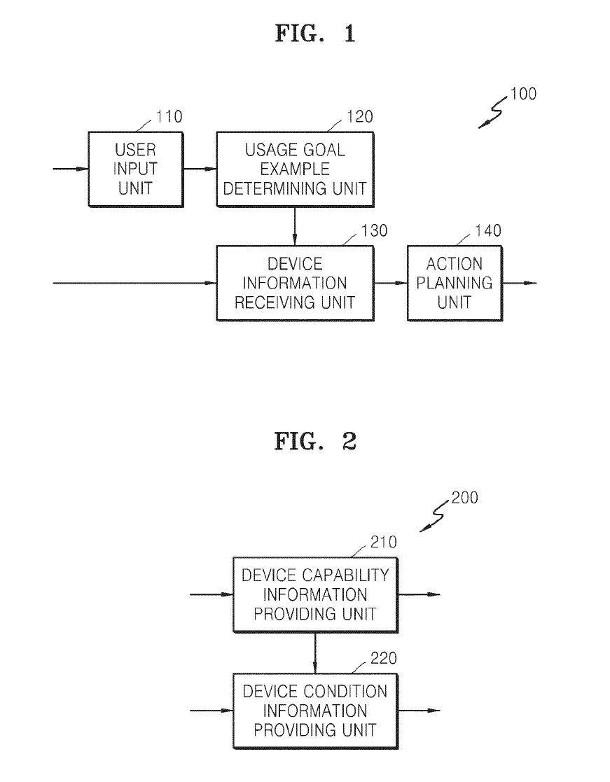

Hereinafter, with reference to FIGS. 1 through 9, integrated control of devices and device information provided therefor according to an exemplary embodiment will be described in detail.

FIG. 1 is a block diagram illustrating an apparatus for integrated control of devices according to an exemplary embodiment.

Referring to FIG. 1, an apparatus 100 for integrated control of devices (or a device integrated-control apparatus 100) according to an exemplary embodiment may include a user input unit 110, a usage goal example determining unit 120, a device information receiving unit 130, and an action planning unit 140. The apparatus 100 serves as an arbitrator for allowing at least one users to control at least one devices.

The user input unit 110 according to an exemplary embodiment receives input from a user indicating an intention to use at least one of the devices. The user input may be an action the user desires to perform, rather than a command for directly instructing execution of a predetermined capability of the device.

For example, the user may input an intention of use of the device, ‘I want to dance’, instead of inputting a command of execution of the device, ‘Play the dance music’. Thus, user input having a predetermined aim is input through the user input unit 110 and is output to the usage goal example determining unit 120.

The device information receiving unit 120 according to an exemplary embodiment receives from the device information about the device, which is necessary for achieving the user's intention. Device capability and status information may include information about the overall capability of the device, which is necessary for executing the usage goal example of the device, information about a condition necessary to execute a function of the device, or information about content as well as the device, as additional information.

The device capability and status information may be directly transmitted to the device integrated-control apparatus 100, or the device information receiving unit 130 may access devices for which usage goal examples are determined, and collect device capability and status information from a database of a corresponding device.

Alternatively, there may be a central server on the web which the device integrated-control apparatus 100 and the devices can access, and the devices may register device capability/functionality and status information in the central server. Thus, the device information receiving unit 130 of the apparatus 100 may access the central server and collect device capability/functionality and status information regarding a desired device.

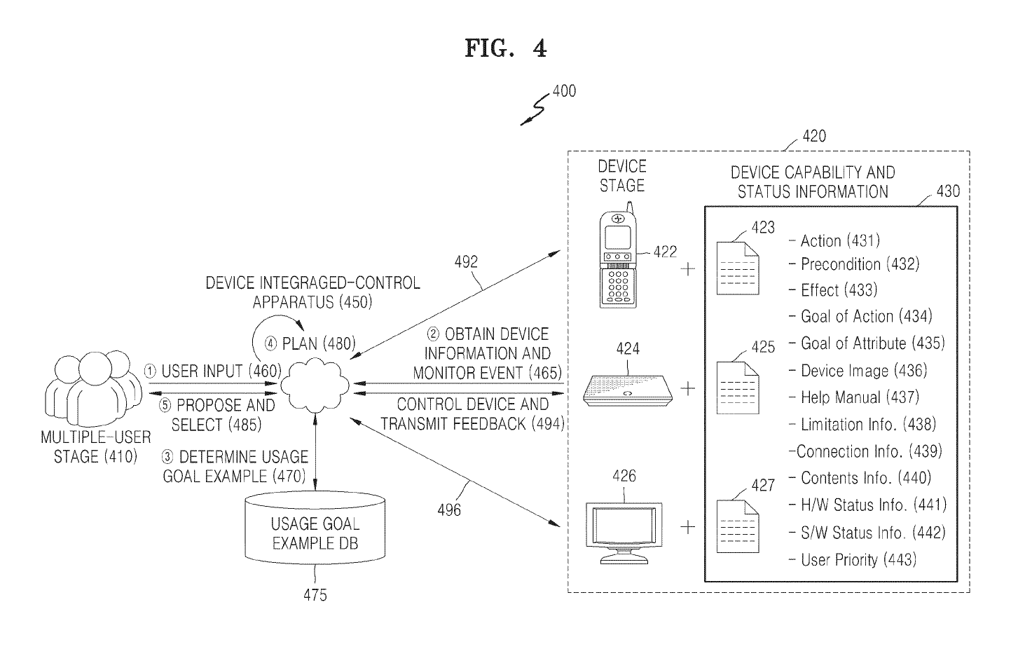

Hereinafter, information about devices necessary for executing usage goal examples for the respective devices will be referred to as ‘device capability and status information’. Detailed examples of the device capability and status information will be described later with reference to FIGS. 4, 5, and 7.

The usage goal example determining unit 120 according to an exemplary embodiment selects a device capable of operating so as to achieve the predetermined aim indicated by the user input from among the at least one devices which is managed by the device integrated-control apparatus 100, by using the device capability and status information input from the device information receiving unit 130. The usage goal example determining unit 120 determines a usage goal example indicating a final status in which the device selected for achieving the predetermined aim indicated by the user input operates.

The usage goal example for achieving the predetermined aim indicated by the user input may be searched in and extracted from a database of the device integrated-control apparatus 100. The usage goal example determining unit 120 according to an exemplary embodiment may determine a usage goal example for each device (or a device-based usage goal example) considering capability and related status of a device based on the device capability and status information.

The action planning unit 140 according to an exemplary embodiment plans device-by-device at least one action which has to be executed to attain the device-based usage goal example, by using the received device capability and status information. By using the device capability and status information, actions which have to be executed until the device reaches from its current status to a goal status corresponding to the device-based usage goal example have to be planned.

When at least one action has to be executed, a series of actions are sequentially planned. By using the device capability and status information, a capability of a device and a condition and a status for execution of the device's capability may be analyzed. When the condition and the status for execution of the device's capability are satisfied, at least one capability of the device, which corresponds to actions necessary for attaining the usage goal example, may be determined in order of time.

The action planning unit 140 according to an exemplary embodiment proposes the device-based planned action to the user and may receive selection of an action from the user.

The device integrated-control apparatus 100 according to an exemplary embodiment may control a device to execute the action planned to attain the device-based usage goal example determined according to the user input.

The device integrated-control apparatus 100 according an exemplary embodiment may receive feedback from the device which performs the planned action. The device integrated-control apparatus 100 according to an exemplary embodiment may determine a new target usage example according to the feedback of the device and may report information about the feedback of the device to the user.

The device integrated-control apparatus 100 according to an exemplary embodiment may be mounted on one of the at least one devices which are interconnected. The device integrated-control apparatus 100 according to an exemplary embodiment may also operate as a management server on the web.

FIG. 2 is a block diagram illustrating a target device 200 which is subject to control of the device integrated-control apparatus 100 according to an exemplary embodiment.

The target device 200 which is subject to control of the device integrated-control apparatus 100 (or the control target device 200) may include a device capability information providing unit 210 and a device status information providing unit 220. The control target device 200 may receive a request for providing predetermined information of a device from a device integrated-controller, such as the device integrated-control apparatus 100 according to an exemplary embodiment.

The device integrated-control apparatus 100 according to an exemplary embodiment plans at least one action which has to be executed to attain a usage goal example of a device determined according to user's needs, and requests the control target device 200 to provide information about a capability and a status of the device, which is necessary for execution of the planned action.

The device capability information providing unit 210 outputs information about at least one capability of a device (or device capability information), which is necessary for execution of the usage goal example of the device capable of satisfying the user's needs.

To attain the usage goal example of the device capable of satisfying the user's needs, the device status information providing unit 220 outputs information about a device status (or device status information) or information about a content status (or content status information) for executing a predetermined capability based on the device capability information output from the device capability information providing unit 210. The device capability information, the device status information, and the content status information provided to the device integrated-control apparatus 100 from the control target device 200 may be included in the aforementioned device capability and status information.

In other words, the information output from the device capability information providing unit 210 and the device status information providing unit 220 may be output to the device integrated-controller such as the device integrated-control apparatus 100 according to an exemplary embodiment. The device status information related to a device's capability may include information about a previous status (or a precondition) prior to execution of a predetermined capability of the device and information about a post status (or an effect) after execution of the predetermined capability. In addition, information about a goal status of the predetermined capability of the device and information about a goal status of the predetermined content for a device-based usage goal example may be provided from the control target device 200 to the device integrated-control apparatus 100.

The device status information and the content status information may include information about device's multimedia, information about a help manual of a predetermined capability of a device, information about limitations, information about external connection, information about hardware status, information about software status, and information about priority for execution of the predetermined capability.

The device integrated-control apparatus 100 may control the control target device 200 to execute the planned action to attain the usage goal example based on the provided device capability and status information.

The control target device 200 may execute an action for attaining the usage goal example according to control of the device integrated-control apparatus 100 based on the provided information. The control target device 200 may report an event occurring during execution of the action under control of the device integrated-control apparatus 100 to the device integrated-control apparatus 100, thereby exchanging feedbacks.

The control target device 200 may not only provide information to the device integrated-control apparatus 100, but also allow the device integrated-control apparatus 100 to access the control target device 200 to obtain information.

By registering the device capability and status information of the control target device 200 in the central server on the web, the device integrated-control apparatus 100 may be provided with the device capability and status information from the central server.

An environment for device integrated control according to an exemplary embodiment is assumed to be a network environment where at least one user, at least one device, and a device integrated-controller are interconnected. Herein, a device may be any type of digital electronic product including a customer electronic (CE) device. For example, various devices, such as a digital TV (DTV), a personal video recorder (PVR), a smart phone, a personal computer (PC), an MP3 player, an audio player, a video player, and a digital photo-frame, may be integrally controlled according to user's needs.

To efficiently use a device connected to a network, an exemplary embodiment adopts action planning, which is one of the fields of the artificial intelligence. In particular, through the device integrated-control apparatus 100 and the control target device 200 according to an exemplary embodiment, the device integrated-control apparatus 100 in place of the user performs goal-oriented action planning which reflects user's needs, thereby allowing the user to control and use various devices without a need to fully know usage examples of the respective devices.

Since the device integrated-control apparatus 100 should have knowledge of various capabilities and current status of the control target device 200 to perform goal-oriented action planning for the control target device 200, the control target device 200 provides various information about its capabilities and status. As long as such information is provided in a standardized manner, a user-friendly device integrated-control environment may be established where the user can easily control and efficiently use various devices connected to the network.

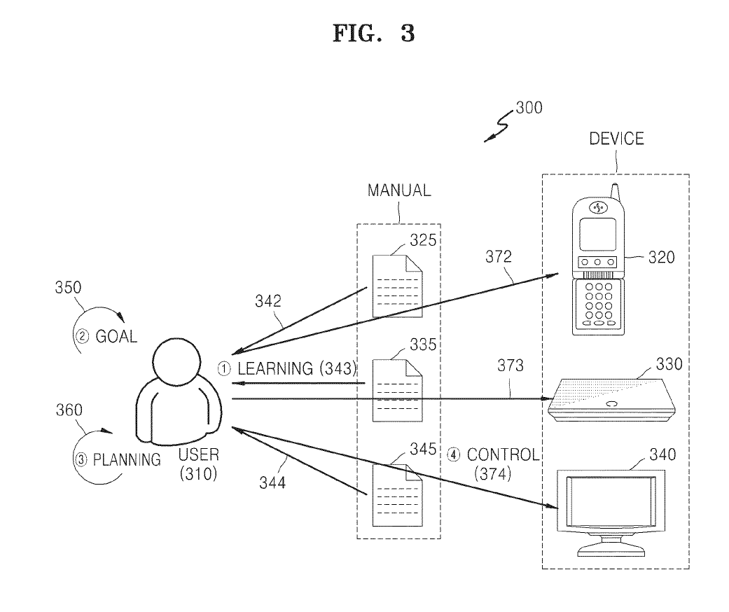

FIG. 3 is a diagram illustrating a related art device use structure in which a user uses various devices.

Referring to FIG. 3, in a related art device use structure 300, to use multiple devices, a user 310 should be familiar with a capability and an interface of each device by learning a manual of each device. That is, the user 310 has to learn a manual 325 of a first device 320 to use the first device 320 in operation 342, learn a manual 335 of a second device 330 to use the second device 330 in operation 343, and learn a manual 345 of a third device 340 to use the third device 340 in operation 344.

The user 310 determines device-based usage goal examples for the first device 320, the second device 330, and the third device 340 in operation 350, and plans device-based actions for attaining the respective device-based usage goal examples in operation 360. The user 310, according to the actions planned by the user 310, controls the first device 320 in operation 372, controls the second device 330 in operation 373, and controls the third device 340 in operation 374.

Therefore, the related-art device use structure 300 adopts direct control between the user 310, and the first device 320, the second device 330, and the third device 340, i.e., multiple devices. For direct control between the user 310 and the multiple devices, the user 310 experiences the inconvenience of having to know a capability and an interface of each device by learning a manual of each device.

FIG. 4 is a diagram illustrating a device use structure in which multiple users use a device through a device integrated-control apparatus according to an exemplary embodiment.

Referring to FIG. 4, a device use structure 400 using a device integrated-control apparatus 450 according to an exemplary embodiment may include a multiple-user stage 410, the device integrated-control apparatus 450, and a multiple-device stage 420 including multiple devices 422, 424, and 426.

In the device use structure 400, control between the multiple-user stage 410 and the multiple devices 422, 424, and 426 is performed by the device integrated-control apparatus 450. Through the device integrated-control apparatus 450, the multiple devices 422, 424, and 426 are accessible at the same time, and resources of the devices 422, 424, and 426 may be distributed to provide desired services to the multiple devices 422, 424, and 426, such that the multiple users may use the multiple devices 422, 424, and 426 at the same time.

The device integrated-control apparatus 450, to control contents and the devices 422, 424, and 426 in place of the users, may perform goal-oriented action planning which includes planning actions of the devices 422, 424, and 426 by recognizing an intention or aim of a predetermined user from an input of the user of the multiple-user stage 410.

The device integrated-control apparatus 450 receive a user input requesting use of a device in operation 460. The user input may be in any form as long as the device integrated-control apparatus 450 can process it. For example, the user input may be in any form, such as a natural language, a mechanical language, a key input, etc.

The device integrated-control apparatus 450 obtains device capability and status information 430 from the devices 422, 424, and 426 in operation 465. The device capability and status information 430 may include information about device-based capabilities and information about device-based current status (or a previous or post status), which are to be included in manuals 423, 425, and 427 of the devices 422, 424, and 426, respectively.

The device capability and status information 430 according to an exemplary embodiment may further include, in addition to the manuals 423, 425, and 427 of the devices 422, 424, and 426, ‘Action’ information 431, ‘Precondition’ information 432, ‘Effect’ information 433, ‘Goal of Action’ information 434, ‘Goal of Attribute’ information 435, ‘Device Image’ information 436, ‘Help Manual’ information 437, ‘Limitation Info.’ information 438, ‘Connection Info.’ Information 439, ‘Contents Info.’ Information 440, ‘H/W Status Info.’ Information 441, ‘S/W Status Info.’ Information 442, and ‘User Priority’ information 443.

The ‘Action’ information 431 is information about a predetermined capability of a device. Such action information is a basic unit for goal-oriented action planning, and is necessary for determining capability used to attain a usage goal example of the device.

For example, information about a predetermined capability of a device, such as a power-on capability, a power-off capability, or the like may be provided as device capability and status information.

The ‘Precondition’ information 432 is information about a previous status (or a precondition) prior to execution of a predetermined capability, as a precondition for execution of the predetermined capability of a device. The predetermined capability of the device may be executed only when the current status of the device satisfies the previous status of the predetermined capability. Thus, the information about the previous status is necessary for checking if the device is in a state capable of executing the predetermined capability during a goal-oriented action planning.

For example, since a condition for the previous status of the power-on capability (Action: PowerOn) is a ‘power-off’ status (Precondition: PowerStatus(Off)), the current status should be the power-off status for execution of the power-on capability.

The ‘Effect’ information 433 is information about a post-status (or an effect) after execution of the predetermined capability of the device as a result of the execution. This information is necessary for expecting a resultant status of the device after execution of the predetermined capability during the goal-oriented action planning.

For example, since the post-status of the power-on capability (Action: PowerOn) is the power-on status (Effect: PowerStatus(On)), the current status is the power-on status after execution of the power-on capability.

The ‘Goal of Action’ information 434 is information about a goal status of the predetermined capability of the device. The goal status of the predetermined capability indicates a final status which is a unique aim of the predetermined capability. When goal-oriented action planning for attaining a usage goal example is performed, information about the goal status of the predetermined capability is checked and whether to adopt the predetermined capability is determined.

For example, the goal status of the power-on capability (Action: PowerOn) may be ‘Power On’, ‘Device operates’, or ‘Device's capability is available’.

The ‘Goal of Attribute’ information 435 is information about a goal status of content which the predetermined capability of the device may use. The goal status of the content is a final status which can be implemented by execution of the content, as a unique aim for which the predetermined capability uses the content to attain the usage goal example of the device. The goal status of the content may include attributes of the content. When goal-oriented action planning is performed, the information about the goal status of the content which the predetermined capability may use is checked, and whether to adopt predetermined content to be executed by the predetermined capability may be determined.

For example, when a user has an intention of ‘listening to the exciting music’ for relaxation, a ‘sound source content play’ capability for playing a sound source content has to be executed, and to determine the exciting sound source content to be played by the ‘sound source content play’ capability, the attribute of the sound source content has to be recognized. Thus, to attain a goal status of the content such that a dance sound source content (Contents: Music(Dance)) having an attribute such as ‘Exciting, ‘Dance’, ‘Not boring’, or the like is played through the ‘sound source content play’ capability, action planning has to be performed.

The ‘Device Image’ information 436 indicates an image of a device provided to provide detailed information to a user in goal-oriented action planning. When the device integrated-control apparatus 450 performs goal-oriented action planning, a case may occur where user's participation is needed for an action which cannot be executed by itself. In this case, the user may easily understand the participation-needed action by referring to the image of the device, and smoothly participate in execution of the capability of the device. Information about multimedia, such as an image of a device, required for providing more detailed information about the device may also be provided.

For example, when an action (Action: HDMIConnect(TV, PVR)) of connecting a TV device with a PVR device through a High-Definition Multimedia Interface (HDMI) cable is needed to record a broadcasting program, the device integrated-control apparatus 450 cannot connect the HDMI cable between the TV device and the PVR device by itself. Thus, the device integrated-control apparatus 450 provides an HDMI cable connection port image of the TV device and the PVR device to the user, thereby helping the user to easily connect the HDMI cable.

The ‘Help Manual’ information 437 is additional information necessary for a goal-oriented action planning or information about a help manual of a predetermined capability of a device. The device integrated-control apparatus 450 provides the additional information necessary for goal-oriented action planning to the user, thereby showing to the user whether the result of the goal-oriented action planning is reasonably drawn.

A capability where a problem occurs during a device control of the device integrated-control apparatus 450 may be excluded or the user may be alerted to the capability. The device integrated-control apparatus 450 may actively promote problem solving by providing a help manual of the capability having the problem to the user. Thus, the help manual information regarding a predetermined capability may include information about a cause, a phenomenon, and a solution for a potential problem and information necessary for execution of, for example, interconnection with a service center.

The ‘Limitation Info.’ information 438 is information about a predetermined capability of a device or a limitation of the device itself. In the information about the device, information about various details having limitations may be provided. This limitation information has to be considered with priority higher than any other capability or goal status information in the goal-oriented action planning. Therefore, the device integrated-control apparatus 450 may preferentially perform action planning for a capability having a limitation among all capabilities of a predetermined device.

For example, when a user desires to play a movie content having a running time of 2 hours, a device-based power supply time has to be considered as a limitation if a power source for a device is a battery. Other limitations may include a limitation regarding the content and a limitation regarding the right to use the device.

A limitation may be set directly by the user. For example, if the user wants to be provided with a usage goal example and a planned final action state from the device integrated-control apparatus 450 as soon as possible, the device integrated-control apparatus 450 has to reduce time spent in action planning such as a content search time.

The ‘Connection Info.’ Information 439 is external connection information of the device for the goal-oriented action planning. By providing information about connectivity and compatibility of the device, the application range of the device may be extended.

For example, for goal-oriented action planning during interconnection between a device A and a device B, external connection information of the device A and the device B is required. The device A may transmit data to an external cable port and the device B may receive data through the external cable port, the device A and the device B may be planned such that they are interconnected to operate, respectively. Information about an external connection scheme or form, such as an HDMI cable port, a universal serial bus (USB) port, or the like, may be provided to the device integrated-control apparatus 450.

The ‘Contents Info.’ Information 440 is information about availability of a content for a predetermined capability of a device. For example, information about a content currently owned by the device, a securable content, and a content which can be played and transmitted may be provided. Such content information is necessary when a device performs the goal-oriented action planning, taking into account a currently owned content or a securable content.

For example, if the device A currently owns 10 music contents, but has an extra memory capable of further securing 100 or more music contents, and the device B currently owns 50 music contents, the device integrated-control apparatus 450 may perform the goal-oriented action planning according to a more important variable for subsequent content such as securability and availability of a current content.

Information about a file coding scheme of a content processible by a device (e.g., a file format such as an MP3, Windows Media Audio (WMA), etc.) and information about possibility of content transmission and reception to and from the device may be provided to the device integrated-control apparatus 450.

The ‘H/W Status Info.’ Information 441 is information about a status of hardware required for attaining a usage goal example of a device. This information may include information about a current hardware status of the device and specification information of the device. The device integrated-control apparatus 450, when selecting one of multiple devices to control a predetermined device, may need the information about the current hardware status of the device and specification information.

For example, when a goal-oriented action planning is performed to initiate washing of a washing machine, a case where the washing machine in operation is stopped to take out some of the laundry from the washing machine and to put new laundry into the washing machine, and a case where it is checked whether there is laundry in the stopped washing machine and new laundry is put into the washing machine, are different in terms of current hardware statuses of the device. Moreover, in case of washing bedclothes, a washing machine having a larger capacity is needed according to a volume of the laundry, and thus, specification information and resource information of the washing machine may be required.

The ‘S/W Status Info.’ Information 442 is information about a status of software required for attaining a usage goal example of a device. This information may include information about a current status of software included in the device and detailed description of the software. The device integrated-control apparatus 450, when selecting one of multiple devices for controlling a predetermined device, may need the information about the current status and the detailed description.

For example, when an MP3 player performs a goal-oriented action planning to play a predetermined sound source content, a case where running sound source content play software of the MP3 player is stopped and a predetermined sound source content is played, and a case where sound source content play software of the MP3 player is newly executed to play the predetermined sound source content, are different in terms of current software statuses of the device. Moreover, when the performance of a sound source play program is considered to play a sound source content with good sound quality, performance information or resource information of the software may be required.

The ‘User Priority’ information 443 is information about a user priority for a device, necessary for attaining a usage goal example of a device. This information is necessary for setting the right to use the device. According to the right to use per user, owner information which allows an owner to have an absolute right to access the device, device sharing information based on the rights of other users to use the device, content sharing information based on the rights of other users to use a content of the device, and information about a priority of the right to use among multiple users may be provided to the device integrated-control apparatus 450.

In addition, the ‘User Priority’ information 443 may also include information about a priority of each device. For example, when there are several TVs which the right to access is provided to the same user, the highest priority may be set for a TV having best display quality and largest screen.

By using examples of the foregoing device capability and status information 430, the device integrated-control apparatus 450 may determine a device-based usage goal example for achieving a user's intention or aim in operation 470.

The device integrated-control apparatus 450 may establish a usage goal example database 475 regarding accessible devices. Thus, the device integrated-control apparatus 450 may search the usage goal example database 475 to determine a device-based usage goal example according to a user's request in operation 470.

The device integrated-control apparatus 450 plan actions which respective devices have to execute for attaining a device-based usage goal example in operation 480. From the device capability and status information, a capability of a device, a status condition for implementing the capability of the device, a device's current status, and so forth may be recognized. Thus, the device integrated-control apparatus 450 may plan actions which the respective devices have to execute for attaining a usage goal example and executable actions in order of time, taking into account the capability and current status of each device.

The device integrated-control apparatus 450 may monitor an event occurring for each device in operation 465. Without direct input of the user's request, upon occurrence of a predetermined event of a device, the device integrated-control apparatus 450 process the predetermined event in the same manner as when the user's request is input, such that the device integrated-control apparatus 450 determines a usage goal example for a corresponding device in operation 470 and starts a goal-oriented action planning for attaining a usage goal example in operation 470.

The device integrated-control apparatus 450 may propose a usage goal example and a planned action for each device to the user to receive user's section of a desired device-based usage goal example in operation 485. The device integrated-control apparatus 450 may control a corresponding device according to actions planned for attaining the device-based usage goal example selected from the user in operations 492, 494, and 496, respectively.

The devices 422, 424, and 426, while operating under control of the device integrated-control apparatus 450, may transmit an occurring event and a feedback regarding statuses in operations 492, 494, and 496, respectively.

An exemplary relationship between a user and a device using the device integrated-control apparatus 450 in the foregoing device use structure 400 will be described below with more detailed examples.

When a user input is ‘I want to dance’ in operation 460, the device capability and status information, which is information about a predetermined capability necessary for attaining a usage goal example, may be received from an MP3 player in operation 465. That is, the device capability and status information of the MP3 player may include information about capabilities such as a ‘power-on capability’, a ‘content play capability’, a ‘content search capability’, etc.

In addition, since a first action may be determined considering a current status of a current device, information about a previous status or a post status of a predetermined capability of the current status, and information about the current status of the current device are required. For example, when the MP3 player is currently in a ‘standby status’, a previous status of the ‘content play capability’ is the ‘standby status’, and a post status thereof is a ‘content play status’, the ‘content play capability’ of the MP3 player may be determined as the first action.

In addition, information about an attribute of a content used by a predetermined device capability for attaining a device-based usage goal example may be needed. That is, information about an attribute of a content, such as whether a content is of dance music and what is a type of the dance music, may be included in the device capability and status information. For example, when a sound source content having a content attribute of ‘dance music’ is searched for to play a sound content of ‘dance music’, information about an attribute of a content is needed.

In other words, the device integrated-control apparatus 450 may perform goal-oriented action planning, by using device capability and status information of the MP3 player which includes information about capabilities such as the ‘power-on capability’, the ‘content search capability’, and the ‘content play capability’, information about a previous status or a post status of each capability, information about a current status of the MP3 player, information about attributes of contents which can be played by the MP3 player, and so forth.

If the user input is ‘I want to dance’ in operation 460, a device-based usage goal example of the MP3 player may be determined as ‘play dance music’ in operation 470. If the current status of the MP3 player is the ‘standby status’, an ‘action of playing a dance music content’ has to be executed until a goal status of ‘play of dance music’ is reached, in operation 480. If the current status of the MP3 player is a ‘power-off status’, a series of actions such as the ‘power-on action’ and the ‘dance music content play action’ have to be planned considering the current status of the device in operation 480.

The device integrated-control apparatus 450 may propose the usage goal example of ‘play dance music’ and the series of planned actions of the ‘power-on action’ and the ‘dance music content play action’ to the user, and receive user's selection in operation 485.

If the user selects to attain the target goal of ‘play dance music’ through the series of planned actions such as the ‘power-on action’ and the ‘dance music content play action’, the device integrated-control apparatus 450 may control the MP3 player to play the dance music content according to goal-oriented action planning in operations 492, 494, and 496.

Consequently, the device integrated-control apparatus 450 performs goal-oriented action planning by matching a user's intention to use a device to a device-based usage goal example based on device capability and status information received from devices connected to a network. Since the device integrated-control apparatus 450 in place of the user performs goal-oriented action planning for each device, the user may control and use multiple devices without being fully aware of a manual of each device or of a usage of an interface, merely with an intention or aim to use the device.

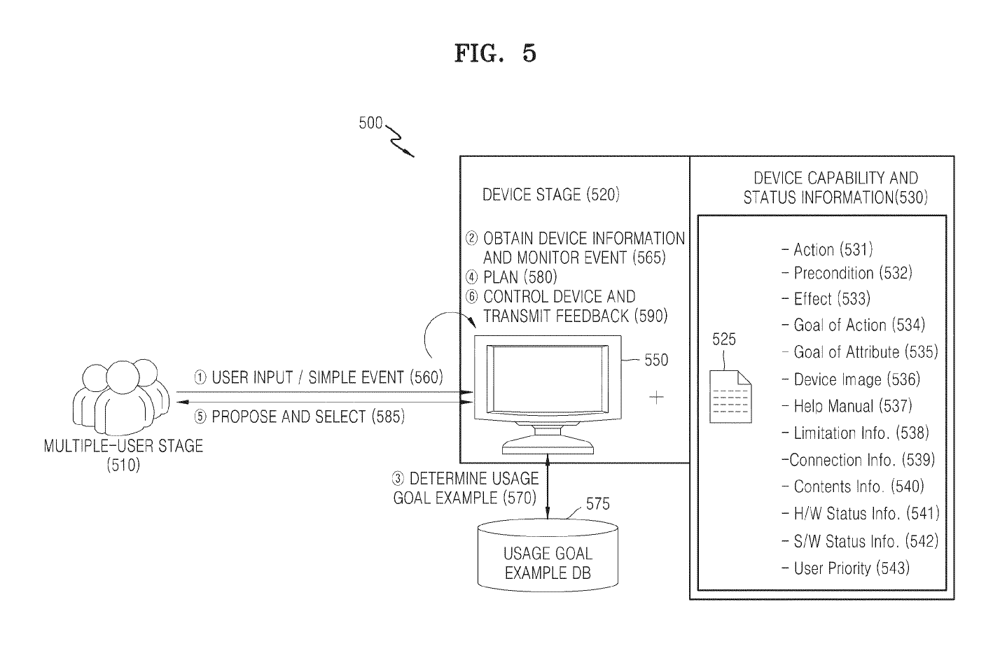

FIG. 5 is a diagram illustrating a device use structure in which a user uses a device having mounted therein a device integrated-control apparatus according to an exemplary embodiment.

Referring to FIG. 5, a device use structure 500 may include a multiple-user stage 510 including multiple users and a device stage 520. The device stage 520 may include a device 550 having mounted a device integrated-control apparatus therein, and a usage goal example database 575. The device stage 520 includes device capability and status information 530, such that a goal-oriented action planning is possible.

The device capability and status information 530 may include not only a manual 525 of the device stage 520, but also ‘Action’ information 531, ‘Precondition’ information 532, ‘Effect’ information 533, ‘Goal of Action’ information 534, ‘Goal of Attribute’ information 535, ‘Device Image’ information 536, ‘Help Manual’ information 537, ‘Limitation Info.’ information 538, ‘Connection Info.’ Information 539, ‘Contents Info.’ Information 540, ‘H/W Status Info.’ Information 541, ‘S/W Status Info.’ Information 542, and ‘User Priority’ information 543. These information 531 through 543 are somewhat analogous to the above described exemplary information 431 through 443 described with reference to FIG. 4.

The device 550 having mounted therein the device integrated-control apparatus according to an exemplary embodiment, upon receiving a user input from a predetermined user of the multiple-user stage 510 in operation 560, analyzes a user's intention to use the device 550. Without direct input of an instruction from the user, upon occurrence of a simple event of the device 550 corresponding to an operation instruction, the user's intention to use the device 550 may be analyzed based on the event in operation 560.

The device 550 obtains its device capability and status information 530 and monitors its current event status in operation 565. The device 550 determines a usage goal example based on the device capability and status information 530 and an event status of the device 550 in operation 570. The usage goal example may be adopted by searching the usage goal example database 575.

The device 550 performs goal-oriented action planning based on the device capability and status information 530 and the event status of the device 550 in operation 580. The device 550 may be controlled according to its planned action and transmit a feedback by reflecting an event occurring during execution of the action, in operation 590.

For example, if the device 550 is a TV, once the user powers on the TV, a power-on event occurs in operation 560, such that the TV starts a goal-oriented action planning. To this end, the device 550 may determine an action, for example, of changing a channel or executing a widget related to a predetermined channel, determine which content is to be executed, and determine from where the determined content is to be provided.

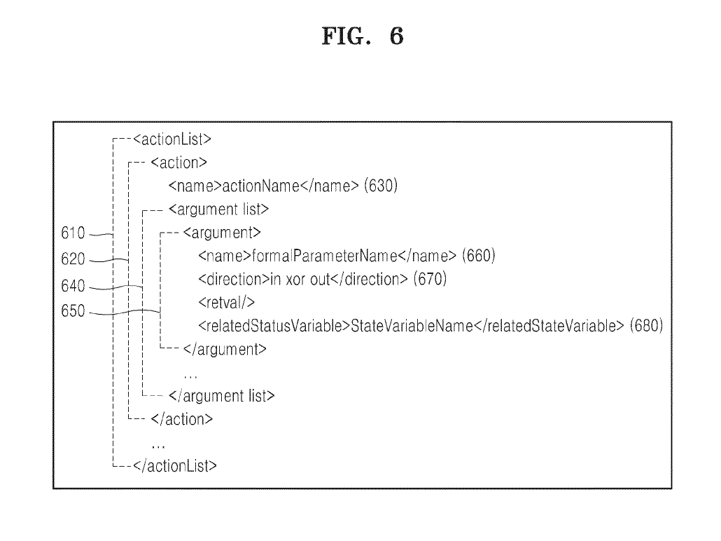

FIG. 6 is a diagram illustrating an example of a pseudo code according to a related art Universal Plug and Play (UPnP) scheme.

An UPnP scheme uses an Extensible Markup Language (XML) to allow communication between devices for a home network.

In the XML used by the related art UPnP scheme, an information tag ‘action’ 620 regarding one or more capabilities are declared under a device capability list tag ‘actionlist’ 610, under each of which a capability name tag ‘name’ 630 and an argument list tag ‘argument list’ 640 are declared. Under the argument list tag ‘argument list’ 640 are declared one or more argument tags ‘argument’ 650, where under each, an argument name tag ‘name’ 660, an action direction tag ‘direction’ 670, and a related status variable tag ‘relatedStatusVariable’ 680 are declared.

Thus, in the related art UPnP scheme, simple information enumerating types of capabilities of devices is described.

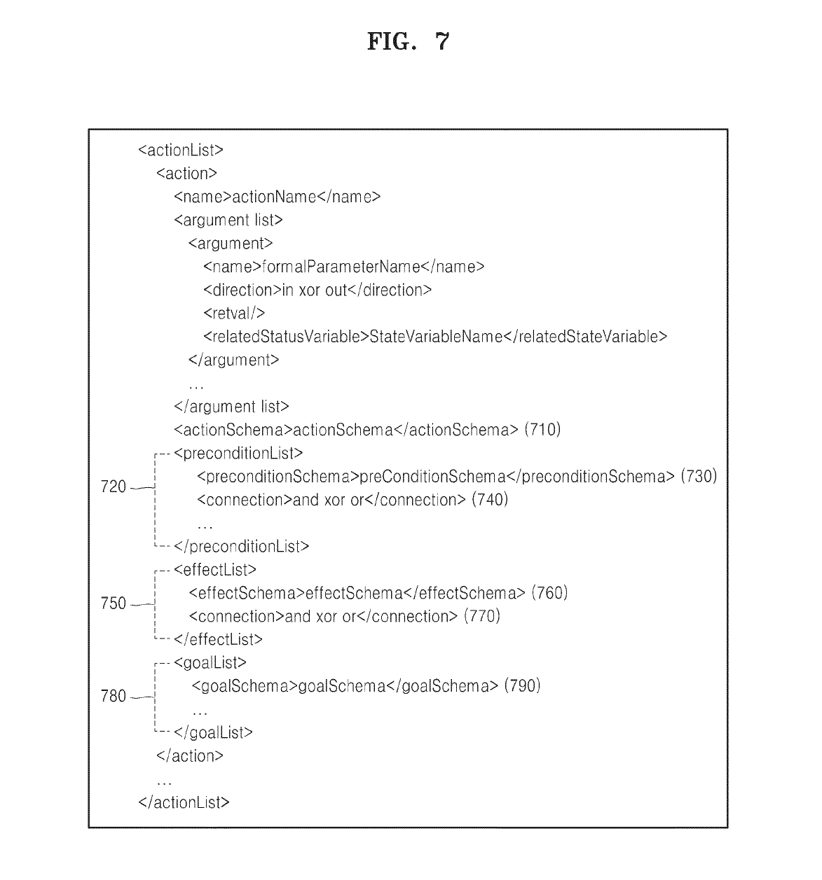

FIG. 7 is a diagram illustrating an example where pseudo code based on an UPnP scheme is extended according to an exemplary embodiment.

To establish an environment where the device integrated-control apparatus 100 can be used for various devices in a wide range of applications, it is necessary to standardize a scheme for describing device information, such as the UPnP scheme. However, since the device integrated-control apparatus 100 according to an exemplary embodiment needs dynamic information, such as information about a status of a device or information about a content, for goal-oriented action planning, unlike in the related art UPnP scheme, information having a new configuration which is distinct from a related art may be added to an XML format.

That is, for a device integrated-control according to an exemplary embodiment, under the device capability list tag ‘actionlist’ a capability schema tag ‘actionSchema’ 710, a previous status list tag ‘preconditionList’ 720, a post status list tag ‘effectList’ 750, and a goal status list tag ‘goalList’ 780, may be added.

The previous status list tag ‘preconditionList’ 720, the post status list tag ‘effectList’ 750, and the goal status list tag ‘goalList’ 780 include a previous status schema tag ‘preConditionSchema’ 730, a post status schema tag ‘effectSchema’ 760, and a goal status schema tag ‘goalSchema’ 790, respectively. The previous status schema tag ‘preConditionSchema’ 730 and the post status schema tag ‘effectSchema’ 760 may include respective status information by connecting those information through connection relationship tags ‘connection’ 740 and 770.

A description format of the device capability and status information shown in FIG. 7 is an exemplary modification of the XML to improve device utilization and compatibility by interconnecting with other standards such as UPnP and secure scalability to a standard. However, such a description format is merely an example for implementing an exemplary embodiment, and it is also possible to adopt technical expressions of various schemes capable of expressing device capability and status information necessary for device integrated-control between multiple users and multiple devices according to goal-oriented action planning.

Moreover, the device capability and status information shown in FIG. 7 includes only information about device's capabilities and statuses, but various information about contents and devices, such as file or information search, may be described in a predetermined description format.

The device capability and status information may be provided directly from the control target device 200 to the device integrated-control apparatus 100, but may also be stored in a predetermined location on the web. The control target device 200 may directly register the device capability and status information in the predetermined location on the web.

When an operator of the control target device 200 (shown in FIG. 2) provides a web service to manage all devices in a production line and registers capability and status information regarding the devices in a predetermined location on the web, the device integrated-control apparatus 100 may access the web service to use a device and be provided with device capability and status information. The web service may be provided through a home network, a peer-to-peer (P2P) network, a server, or the like.

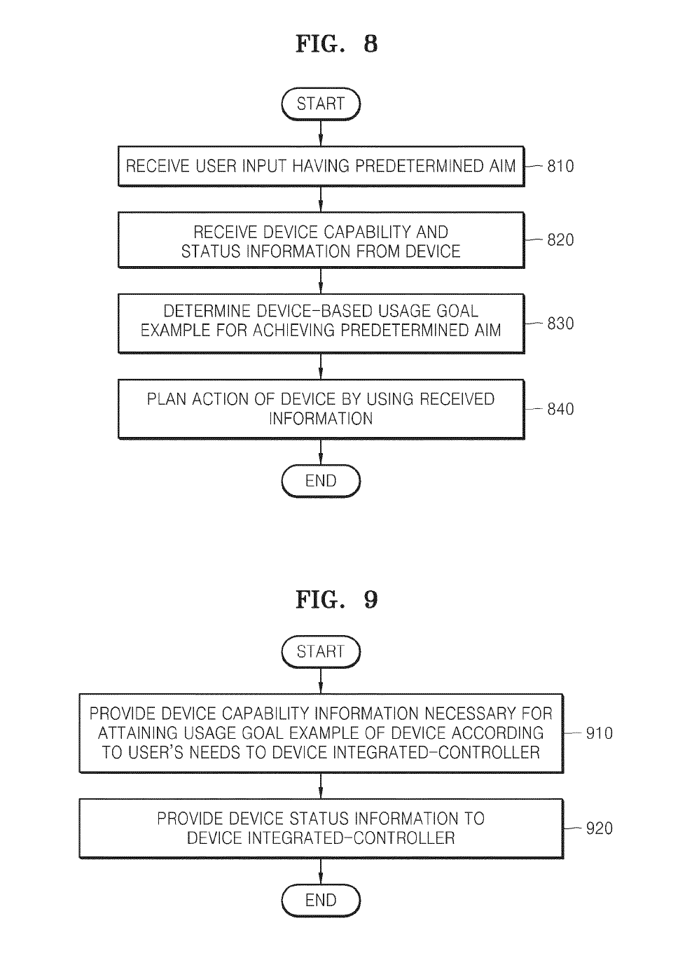

FIG. 8 is a flowchart illustrating a method of integrated control of devices (or a device integrated-control method) according to an exemplary embodiment.

In operation 810, a user input including a predetermined aim to use at least one accessible device is received. The user input is a user's intention or aim to use the device, and may be in any recognizable form such as a natural language, a mechanical language, a key input, or the like. Without direct input from the user, upon occurrence of a predetermined simple event in the device, such an event is regarded as the intention to use the device, and thus the device integrated-control method may start.

In operation 820, device capability and status information is received from the at least one accessible device. The device capability and status information may be provided directly from the device, but may also be registered or stored in an administrator side on the web and downloaded through the web.

The device capability and status information may include overall information regarding the device, such as information about a capability of each device which has to be known thoroughly for use of the device, information about a previous status or a post status of a capability of the device, information about a goal status of a capability of the device or a goal status of a content, a help manual for the device, a limitation of the device, external connection details, information about a hardware status or a software status, information about the right to use the device, information about priority, etc.

In operation 830, a device-based usage goal example capable of achieving the user's predetermined aim is determined based on the device capability and status information. A device capable of achieving the predetermined aim is determined by using the device capability and status information, and a usage example capable of achieving the user's predetermined aim is determined for the determined device. The device-based usage goal example may be extracted from a usage goal example database in which possible device-based usage examples are stored.

In operation 840, by using the device capability and status information, for each device for which a usage goal example is determined, at least one action which has to be executed to attain the usage goal example is planned. To this end, by using the device capability and status information, a capability of the device, and condition and status for executing the capability of the device may be analyzed. When the condition and status for executing the capability are satisfied, the at least one capability of the device corresponding to the action necessary for attaining the usage goal example may be determined in order of time.

By controlling a corresponding device based on at least one action planned by the device integrated-control method, a user's aim to use the device may be achieved. The device may also return an occurring event and a status of a problem occurring during operation according to a usage goal example to the user or the device integrated-control apparatus.

FIG. 9 is a flowchart illustrating a device integrated-control method according to an exemplary embodiment.

FIG. 9 assumes a network environment where at least one user, at least one device, and a device integrated-controller are connected.

In operation 910, in order for the device integrated-controller to perform goal-oriented action planning according to user's needs, information about at least one capability of a predetermined device necessary for attaining a usage goal example of the device is provided from the predetermined device to the device integrated-controller.

In operation 920, information about a device status and information about a content status for executing at least one capability of the device are provided from the device to the device integrated-controller.

The information about the at least one capability of the device, the information about the device status, and the information about the content status may be a part of the device capability and status information. Through a network to which a user, a device, and the device integrated-controller are connected, the device capability and status information may be transmitted directly from the device to the device integrated-controller.

Alternatively, a personal user who desires efficient device control or an operator who desires to provide a service through an integrated control of devices in the same production line may register the device capability and status information in a central control stage on the web, and the device integrated-controller may be provided with the device capability and status information from the central control stage through the web.

Meanwhile, exemplary embodiments can be embodied as a program that can be implemented on computers and can be implemented in general-purpose digital computers that execute the program using computer-readable recording media. Examples of the computer-readable recording media include non-transitory, tangible computer-readable recording medium such as magnetic storage media (e.g., read-only memory (ROM), floppy disks, and hard disks), optical data storage devices (e.g., CD-ROMs and digital versatile discs (DVD)), and transitory storage media such as carrier waves (e.g., transmission over the Internet).

While exemplary embodiments have been particularly shown and described, it will be understood by those of ordinary skill in the art that various changes in form and details may be made therein without departing from the spirit and scope of the invention as defined by the appended claims. Accordingly, the exemplary embodiments should be considered in an illustrative sense only and not for purposes of limitation. The scope of the present invention is defined not by the detailed description of the exemplary embodiments but by the appended claims, and all the differences within the scope should be construed as being included in the present invention.

1. A method for integrated control of at least one device, the method comprising:
receiving a user input which requests a predetermined action;
receiving device functionality and status information from the at least one device;
determining functionality needed by the at least one device to achieve the predetermined action based on the received device functionality and status information; and
planning at least one device action, which is to be executed to attain the determined functionality based on the received device functionality and status information.

2. The method of claim 1, further comprising:
controlling a corresponding device according to the planned at least one action.

3. The method of claim 1, wherein the planning comprises:
proposing the planned at least one device action to a user; and
receiving at least one selection of the planned at least one device action from the user.

4. The method of claim 1, wherein the device functionality and status information comprises at least one of:
information about a predetermined capability needed to attain the determined functionality from capabilities of a predetermined device selected from devices determined to execute the planned at least one device action,
information about a previous status of the predetermined device prior to execution of a predetermined capability of the predetermined device, and
information about a post status of the predetermined device after execution of the predetermined capability of the predetermined device.

5. The method of claim 4, wherein the device capability and status information further comprises at least one of information about a goal status of a predetermined capability of the predetermined device and information about a goal status of a predetermined content for the determined functionality of the predetermined device.

6. The method of claim 4, wherein the device capability and status information further comprises at least one of:
information about multimedia capability of the predetermined device,
information about a help manual of a predetermined functionality of the predetermined device,
information about a limitation of the predetermined device,
information about external connection details of the predetermined device,
information about a hardware status of the predetermined device,
information about a software status of the predetermined device, and
information about a priority for executing a predetermined functionality of the predetermined device.

7. The method of claim 2, further comprising:
receiving a feedback regarding an action of the controlled device.

8. The method of claim 7, further comprising:
planning at least one action for a new determined functionality needed by the at least one device according to the feedback.

9. The method of claim 7, further comprising:
reporting information about the feedback to a corresponding user.

10. The method of claim 1, wherein the determining comprises:
monitoring a current event of the device; and
determining functionality needed by the at least one device based on the received device functionality and status information and the monitored current event of the device.

11. The method of claim 1, wherein the receiving of the device functionality and status information comprises:
accessing a central server on the web and collecting the device functionality and status information registered by a corresponding device in the central server.

12. The method of claim 1, wherein the functionality needed by the at least one device is extracted from a database for the integrated control of the at least one device.

13. The method of claim 1, wherein the method is performed by determining a predetermined device among devices which has at least one functionality from the determined functionality needed is.

14. The method of claim 1, wherein the method is performed by a predetermined control server on the web.

15. A device information providing method for device integrated-control, the device information providing method comprising:
providing by a device information about at least one function of the device necessary for attaining functionality needed to satisfying a predetermined action requested by user to a device integrated-controller; and
providing by a predetermined device information about statuses of at least one of the device and content for executing the at least one function by the predetermined device to the device integrated-controller,
wherein the device integrated-controller receives a user input which requests the predetermined action, receives device functionality and status information from the at least one devices, determines functionality needed by the device to achieve the predetermined action based on the received device functionality and status information, and plans at least one device action, which is to be executed to attain the determined functionality, based on the received device functionality and status information.

16. The device information providing method of claim 15, further comprising:
executing, by the device, at least one actions planned by the device integrated-controller for attaining the determined functionality needed by the at least one device according to control of the device integrated-controller.

17. The device information providing method of claim 15, wherein the information about statuses of the at least one of the device and the content comprises at least one of information about a previous status prior to execution of a predetermined functionality of the device, and information about a post status after execution of the predetermined functionality of the device.

18. The device information providing method of claim 16, wherein the information about statuses of the at least one of the device and the content comprises at least one of information about a goal status of a predetermined functionality of the device and information about a goal status of a predetermined content for the determined functionality needed of the device.

19. The device information providing method of claim 18, wherein the information about statuses of the at least one of the device and the content further comprises:
at least one of information about multimedia capabilities of the device,
information about a help manual of a predetermined functionality of the device,
information about a limitation of the device,
information about external connection details of the device,
information about a hardware status of the device,
information about a software status of the device, and
information about a priority for executing a predetermined functionality of the device.

20. The device information providing method of claim 16, further comprising:
reporting, by the device, a feedback regarding an action executed according to control of the device integrated-controller to the device integrated-controller.

21. The device information providing method of claim 15, further comprising:
providing information about a current event of the device to the device integrated-controller.

22. The device information providing method of claim 15, further comprising:
registering, by the device, information to be provided to the device integrated-controller, in a central server on the web and permitting an access of the device integrated-controller to the central server on the web.

23. An apparatus for integrated control of at least one device, the apparatus comprising:
a user input unit which receives a user input which requests a predetermined action;
a device information receiving unit which receives device functionality and status information from the at least one device;
a functionality determining unit which determines functionality needed by the at least one device to achieve the predetermined action based on the received device capability and status information; and
an action planning unit which plans at least one device action, which has to be executed to attain the determined functionality, based on the received device capability and status information.

24. The apparatus of claim 23, wherein the apparatus controls a corresponding device according to the planned at least one device action.

25. The apparatus of claim 23, wherein the action planning unit proposes the planned at least one action to a user and receives at least one selection of the planned at least one action from the user.

26. The apparatus of claim 23, wherein the device functionality and status information comprises at least one of:
information about a predetermined capability used to attain the needed functionality from capabilities of a predetermined device from the devices utilized to obtain the needed functionality,
information about a previous status prior to execution of a predetermined functionality of the predetermined device,
information about a post status after execution of the predetermined functionality of the predetermined device,
information about a goal status of a predetermined functionality of the predetermined device,
information about a goal status of a predetermined content for the needed functionality of the predetermined device,
information about multimedia capability of the predetermined device,
information about a help manual of a predetermined functionality of the predetermined device,
information about a limitation of the predetermined device,
information about external connection details of the predetermined device,
information about a hardware status of the predetermined device,
information about a software status of the predetermined device, and
information about a priority for executing a predetermined functionality of the predetermined device.

27. The apparatus of claim 24, wherein the apparatus receives a feedback regarding an action of the controlled device.

28. A device controlled by a device integrated-controller, the device comprising:
a device functionality information providing unit which provides from the device to a device integrated-controller, information about at least one functionality of a device necessary for attaining functionality needed to satisfying a predetermined user action; and
a device status information providing unit which provides from the predetermined device to the device integrated-controller information about statuses of at least one device and content for executing the at least one functionality,
wherein the device integrated-controller receives a user input which requests a predetermined action, receives device functionality and status information from the at least one device, determines functionality needed by the at least one device to achieve the predetermined action based on the received device functionality and status information, and plans at least one device action, which is to be executed to attain the determined functionality based on the received device capability and status information.

29. The device of claim 28, wherein the device executes at least one action planned by the device integrated-controller for attaining the needed functionality according to control of the device integrated-controller.

30. The device of claim 28, wherein the device functionality and status information comprises at least one of:
information about a predetermined functionality used to attain the needed functionality of a predetermined device from the devices for which the needed functionality is determined,
information about a previous status prior to execution of a predetermined functionality of the predetermined device,
information about a post status after execution of the predetermined functionality of the predetermined device,
information about a goal status of a predetermined functionality of the predetermined device,
information about a goal status of a predetermined content capabilities for the usage goal of the predetermined device,
information about multimedia content of the predetermined device,
information about a help manual of a predetermined functionality of the predetermined device,
information about a limitation of the predetermined device,
information about external connection details of the predetermined device,
information about a hardware status of the predetermined device, information about a software status of the predetermined device, and information about a priority for executing a predetermined capability of the predetermined device.

31. The device of claim 28, wherein the device reports a feedback regarding an action executed according to control of the device integrated-controller to the device integrated-controller.

32. A computer-readable recording medium having recorded thereon a program for executing a method for integrated control of at least one devices according to claim 1.

33. A computer-readable recording medium having recorded thereon a program for executing a device information providing method according to claim 15.

34. The device information providing method of claim 15, wherein the user input is in a form of a natural language, a mechanical language, or a key input, wherein the determining comprises determining functions of devices from the at least one device that are needed to execute the predetermined action, and wherein the planning comprises generating a plan in which the determined functions of the devices are executed in a planned order to execute the predetermined action.
